(19) United States
(12) Patent Application Publication
(10) Pub. No.: US 2008/0071571 A1
(43) Pub. Date: Mar. 20, 2008

(54) Methods and systems for using practice management data

(75) Inventors: Back Kim, Kew Gardens, NY (US); John Atanasio, Yardley, PA (US)

Correspondence Address: KENYON & KENYON LLP, ONE BROADWAY, NEW YORK, NY, 10004, US

(73) Assignee: Synamed LLC

(21) Appl. No.: 11/716,241

(22) Filed: Mar. 8, 2007

Related U.S. Application Data
(60) Provisional application No. 60/781,231, filed on Mar. 10, 2006.

(51) Int. Cl. G06Q 50/00

(52) U.S. Cl. 705/2

(57) ABSTRACT

A software method and/or system is provided which may extract clinical data directly from an electronic medical record. This data may be used to encourage patient compliance with his prescribed medication. The data may also be used for various market or clinical research purposes.

### RELATED APPLICATIONS AND PRIORITY CLAIM

This application is generally related to U.S. application Ser. No. 10/141,311 filed May 8, 2002, and U.S. application Ser. No. 10/400,460, filed Mar. 28, 2003. The entire disclosures of those applications are incorporated herein by reference thereto. This application claims priority to U.S. Provisional application Ser. No. 60/781,231, filed Mar. 10, 2006. The entire disclosure of said application is incorporated herein by reference thereto.

### BACKGROUND

Clinical patient data is a valuable commodity and serves many purposes. Presently, pharmaceutical companies utilize prescription data to analyze different aspects of their drugs versus their competitors. However, there is a significant lag time before the pharmaceutical companies have access to this information. From the time that a doctor writes a prescription for a patient to the time it is available to the pharmaceutical companies, there may be a delay of two months or more.

Also, the prescription information that is made available to the pharmaceutical companies is incomplete. It is generally not associated with other critical patient information or information about the patient's behavior. For example, the data does not include why a particular drug was prescribed to this patient, or why a certain drug was discontinued for a certain patient.

There are currently Electronic Medical Records (EMR) systems in which the doctor inputs a patient's clinical data electronically and it is stored, but these EMR systems use private servers to store their information, which are very costly to maintain. Prior related application Ser. Nos. 10/141,311 and 10/400,460 generally describe an integrated web-based Application Service Provider (ASP) to store EMR information, while providing data input and access capabilities to clinicians. This decreases the cost of maintaining the records, and allows integration of various types of data.

### BRIEF DESCRIPTION OF THE DRAWINGS

FIG. 1 is a simplified block diagram of an example system, according to an example embodiment of the present invention;

FIG. 2 is a simplified block diagram of an alternative example system, according to an example embodiment of the present invention;

FIG. 3 is a flowchart illustrating an example procedure, according to an example embodiment of the present invention;

FIG. 4 is a flowchart illustrating another example procedure, according to an example embodiment of the present invention;

FIG. 5 is a flowchart illustrating another example procedure, according to an example embodiment of the present invention;

FIG. 6 is a flowchart illustrating another example procedure, according to an example embodiment of the present invention;

FIG. 7 illustrates the operation of an example application according to an example embodiment of the present invention;

FIG. 8 illustrates an example decision tree that operates in conjunction with an electronic medical record (EMR) when the clinician initiates, changes, or discontinues medication, according to an example embodiment of the present invention.

### DETAILED DESCRIPTION

Embodiments of the present invention work cooperatively with existing servers that store clinical patient data (EMR or electronic medical records) at the point of clinical delivery and make it available to others for various purposes. When a doctor examines a patient, he may input the patient's clinical and prescription information into an EMR, as described in U.S. application Ser. Nos. 10/141,311 and 10/400,460. This information may include a patient's prescribed medication, medical condition, geographic location, patient age, or other prescribed medications, and other information. The data may be stored onto a server. Others may then retrieve the stored data located on the server, and use it for various purposes. The doctor may also be able to note his reasons for prescribing, changing and/or discontinuing a drug. The reasoning noted by the doctor may also be uploaded and saved on the server in conjunction with the patient's other clinical information. The patient's compliance with the drug may be detected using the information stored on the server, and the patient may be able to be reminded automatically if he does not comply with his recommended dosage. Alternatively, the prescription and patient data may be retrieved directly from the EMR system and used for various research purposes. For example, the information may be used to identify prescription that indicate the use of a generic, or to analyze the reported side effects.

One example embodiment of the present invention may include a method that receives data from a clinician practice management system, including prescription data. The data may be forwarded to a server. A third-party follow-up activity with patients may be generated, based at least in part on the prescription data. In some example embodiments of the present invention, the prescription data may include data on prescriptions made by multiple clinicians at multiple locations. In some example embodiments of the present invention, the prescription data may be initially received at the clinician practice management system by direct input from clinicians. In some example embodiments of the present invention, the prescription data may include initial prescription information, discontinued prescription information, or changed prescription information. In some example embodiments of the present invention, the follow-up activity may include calling a patient to encourage compliance with the prescription. In some example embodiments of the present invention, the follow-up activity may include providing the patient with educational information about the benefits of complying with the prescription. In some example embodiments of the present invention, the follow-up activity may occur by way of interactive voice response telephony. In some example embodiments of the present invention, the data received from the clinician practice management system may also include the patient's medical condition, geographic location, age, or other prescribed medications, and the patients may be identified for the third-party follow-up activity based on some or all of this extra information received. In some example embodiments of the present invention, the patients may be identified for the third-party follow-up activity based on prescribed medication, medical condition, geographic location, patient age, and/or other prescribed medications. In some example embodiments of the present invention, the data may be received from an application service provider which provides electronic medical record management for many clinicians located in a variety of locations.

Other example embodiments of the present invention may include a method that receives data directly from clinician practice management software, including prescription data. The data may be aggregated. The aggregated data may be used for clinical research or market research. In some example embodiments of the present invention, patient identifying information may be removed from the data. In some example embodiments of the present invention, the data may be received in real-time. In some example embodiments of the present invention, the received data may also include patient's clinical diagnoses, geographic location, age, or other prescribed medications. In some example embodiments of the present invention, the received data may also include the clinician's reasons for initiating, changing, and/or discontinuing medication. In some example embodiments of the present invention, the patient's prescribed medication dosage may be compared with the FDA's approved dosage of the patient's prescribed medication in light of the patient's diagnosis, and prescriptions that are not associated with FDA approved indications may be identified. In some example embodiments of the present invention, prescriptions that indicate the use of a generic may be identified. In some example embodiments of the present invention, the aggregated data may be analyzed by geography. In some example embodiments of the present invention, medication refills may be analyzed by geographic location. In some example embodiments of the present invention, reported side effects of medications may be analyzed. In some example embodiments of the present invention, the aggregated data may be analyzed by indication. In some example embodiments of the present invention, the data may be received from an application service provider which provides electronic medical record management for many clinicians located in a variety of locations.

Other example embodiments of the present invention may include a medical information system consisting of an input device to receive prescription data and patient medical data in a clinical setting. This input device may be operated by a variety of individuals in a clinical setting, including a doctor, a nurse, a nurse practitioner, a physician's assistant, or any other individual who is capable of inputting clinical data or who is authorized to do so. The medical information system may also include a server to receive the prescription and patient data from many clinicians in a variety of locations. Further, the medical information system may include a processor which is capable of aggregating the data which it receives. Finally, the medical information system may also include an output device which is capable of outputting the aggregated data. In some example embodiments of the present invention, the output device may be able to display a report using the aggregated data. In some example embodiments of the present invention, the output device may be able to send the aggregated data to another processor for analysis. In some example embodiments of the present invention, the processor may be able to remove patient identifying information from the prescription data and patient medical data. In some example embodiments of the present invention, the processor may be able to aggregate the prescription and patient data in real-time. In some example embodiments of the present invention, the patient medical data may include clinical diagnoses, geographic location, patient age, and/or other prescribed medications. In some example embodiments of the present invention, the prescription data may include the clinicians' reasons for initiating, changing, and/or discontinuing medication. In some example embodiments of the present invention, the server may be an application service provider which provides practice data management for many clinicians in a variety of locations.

Other example embodiments of the present invention may include a medical information system consisting of an input device to receive prescription data and patient medical data in a clinical setting. This input device may be operated by a variety of individuals in a clinical environment, including a doctor, a nurse, a nurse practitioner, a physician's assistant, or any other individual who is capable of inputting clinical data or who is authorized to do so. The medical information system may also include a server which communicates with the input device to receive the prescription and patient data from many clinicians in a variety of locations. The medical information system may also include a processor which communicates with the server to select certain patients for a third-party follow-up activity based on the data. The medical information system may also include an output device which communicates with the processor to facilitate a third-party follow-up activity for the patients selected by the processor. In some example embodiments of the present invention, the prescription data may include initial, discontinued, and/or changed prescription information. In some example embodiments of the present invention, the output device may operate by interactive voice recognition telephony. In some example embodiments of the present invention, the output device may be able call a patient to encourage compliance with a prescription. In some example embodiments of the present invention, the output device may be able to provide the patient with educational information about the benefits of complying with a prescription. In some example embodiments of the present invention, the patient medical data received may include medical condition, geographic location, age, and/or other prescribed medications. In some example embodiments of the present invention, the processor may be able to identify patients for the third-party follow-up activity based on prescribed medication, medical condition, geographic location, patient age, and/or other prescribed medications. In some example embodiments of the present invention, the server may be an application service provider which provides practice data management for many clinicians in a variety of locations.

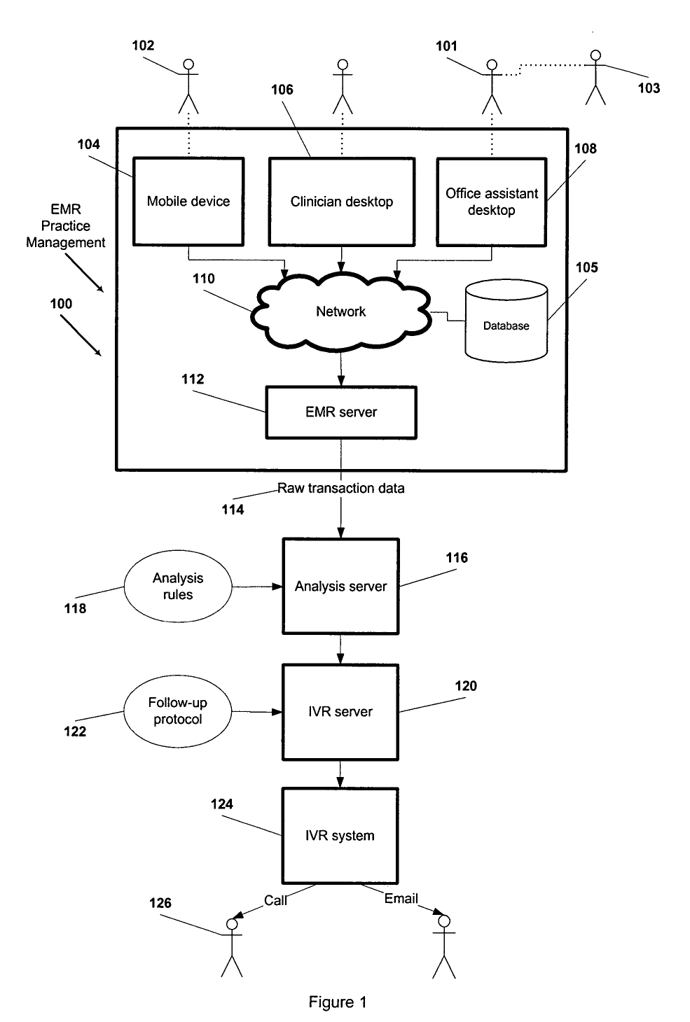

FIG. 1 is a simplified block diagram of an example system, according to an example embodiment of the present invention. A clinician 102 may input a patient's clinical information and prescription information into an EMR by way of an input/output device, such as a keyboard or mouse, for example, attached to a desktop 106. In addition, the information may be inputted via a mobile device 104. The information may alternatively be inputted by another individual 101 in the clinical environment, such as a nurse or a physician's assistant via an office assistant desktop 108. This individual 101 may be instructed on what to input by a clinician 103. The prescription information may include data relating to initial prescription information, changed prescription information, and/or discontinued patient information. For example, the clinician may indicate that he discontinued a particular medication because of adverse side effects. The patient's clinical information may include the prescribed medication, medical condition, geographic location, patient age, and/or other prescribed medications. Once the information is inputted onto the network 110, it may be stored in a database 105. The information may be forwarded to the EMR server 112 directly from the network 110 or from the database 105. The EMR server 112 may be an application service provider. The server 112 may receive clinical and prescription data from many clinicians in different locations. This process of collecting information in the form of electronic medical records is part of “electronic practice management” 100, and may be implemented using the method and systems in application Ser. Nos. 10/141,311 and 10/400,460, cited above. Once the electronic practice management system 100 has received the raw transaction data 114, it may forward the data to an analysis server 116. The analysis server 116 may then analyze the data using the analysis rules 118 that it may receive. For example, the analysis rules may be to choose patients based on age, such as all patients over the age of sixty-five. As another example, the analysis rules may be to choose all patients from a certain geographic location, such as New York City. As another example, the analysis rules may contain several parameters, such as to choose all patients with a certain health condition that are over a certain age, such as patients with heart disease that are over seventy years old. Then, the analysis server 116 may forward the analyzed data to the interactive voice recognition (IVR) server 120. The IVR server 120 may decide on the follow-up activity based on the follow-up protocol 122 that it may receive. For example, the follow-up protocol may be to telephone all patients with a heart condition to remind them to take their medication. As another example, the follow-up protocol may be to email teenagers in New York City to encourage them not to smoke. Thereafter, the IVR server 120 may forward the instructions regarding the follow up activity to the IVR system 124 to carry out the follow-up instructions. The follow-up activity may be, for example, contacting a patient 126 to remind him to take his medication or to provide him with educational information about the benefits of complying with the prescription. This contact may occur via telephone. This phone call may be automatic, using interactive voice telephony. Alternatively, the phone call may be made by a human. The contact may also be via email, fax, or any other mechanism capable of relaying the desired message to the patient 126.

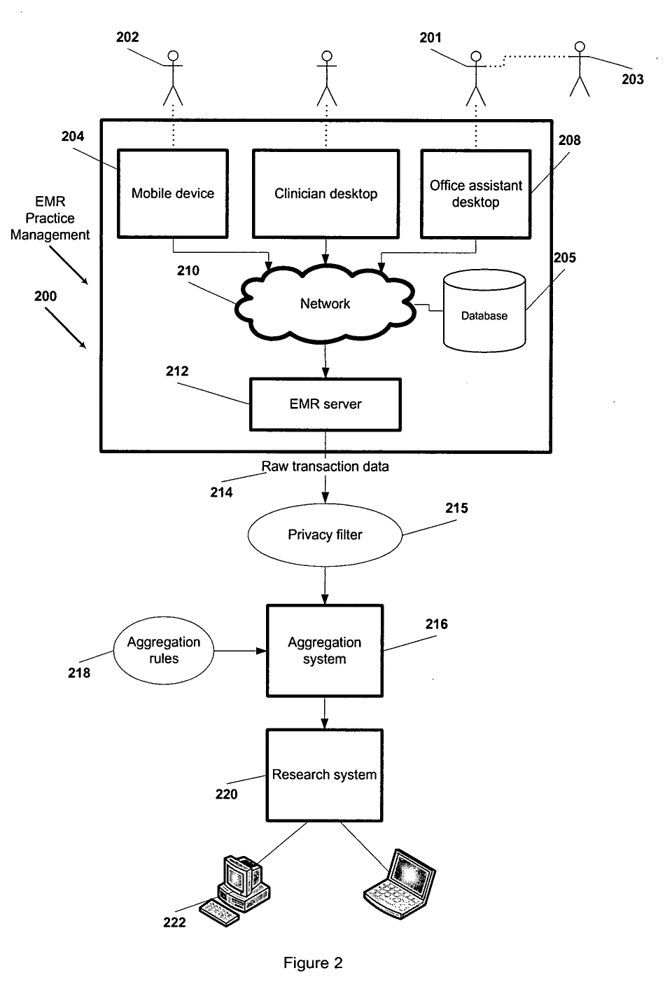

FIG. 2 is a simplified block diagram of an alternative example system, according to an example embodiment of the present invention. FIG. 2 illustrates the identical EMR practice management system 200 as FIG. 1. Once the electronic practice management system 200 has received the raw transaction data 214, it may forward the data to a privacy filter 215 to remove patient identifying information. For example, information that may serve to uniquely identify a patient may be removed, such as name, social security number, telephone number, home address, or any other identifying information. The data may then be sent to an aggregation system 216 for processing. The aggregation system may be, for example, a processor, a data processing unit, or any other system capable of organizing data. The aggregation system 216 may aggregate the data using the aggregation rules 218 that it receives. For example, the aggregated rules may be to sort the data according to the medication the patient is taking. As another example, the aggregation rules may be to sort the data according to the medical condition of the patient. After the aggregation system 216 aggregates the data, it may forward it a research system 220. The research system may be, for example, a private server, a web-based application service provider or any other system capable of housing the aggregated data. The aggregated data may they be made available to various users 222.

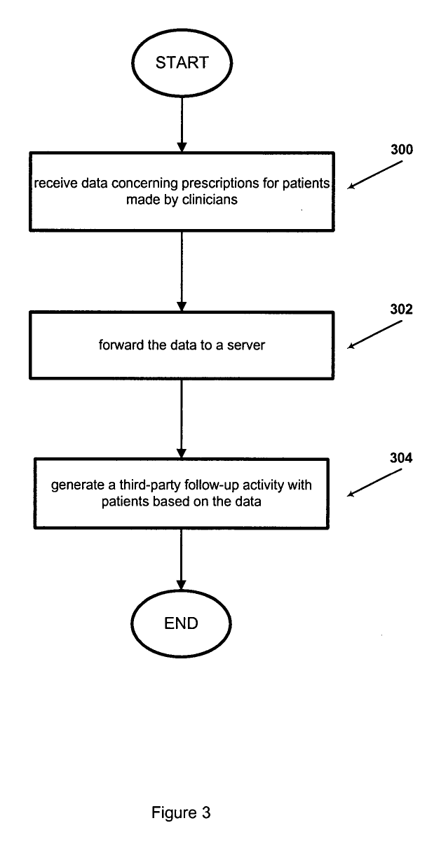

FIG. 3 is a flowchart illustrating an example procedure, according to an example embodiment of the present invention. In 300, data concerning prescriptions for patients made by clinicians may be received. The data may be received, for example, by an EMR practice management system. In 302, the data may be forwarded to a server. The data may be forwarded, for example, by an EMR practice management system. In 304, a third-party follow-up activity may be generated with certain patients based on the forwarded data. For example, the third party follow-up activity may be contacting patients to remind them to take their medication. As another example, the third party follow-up activity may be contacting patients to encourage them to comply with their prescribed medications.

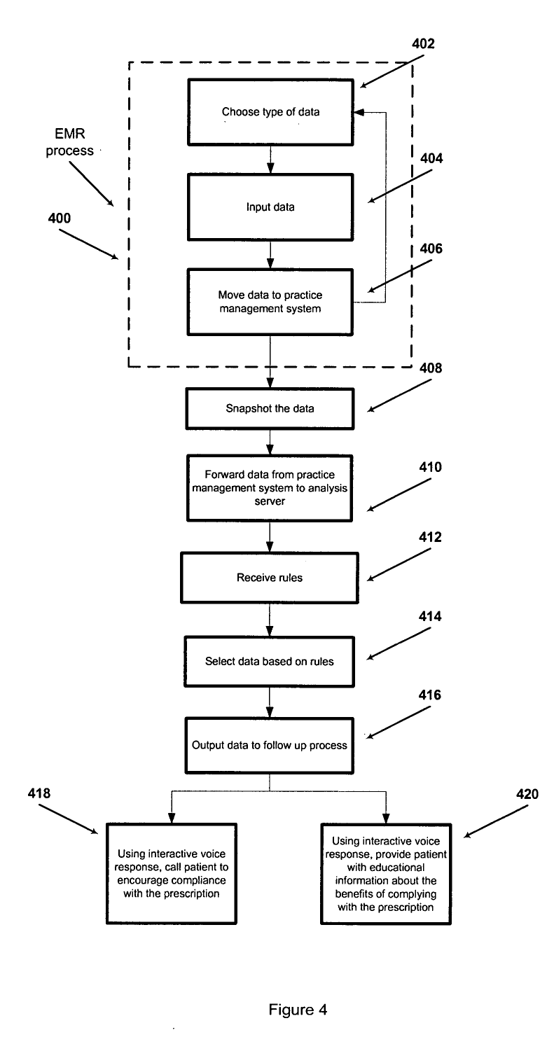

FIG. 4 is a flowchart illustrating another example procedure, according to an example embodiment of the present invention. In 402, the type of data to input may be chosen. This data may include initial, changed and/or discontinued prescription data. For example, a clinician may indicate that he is initiating a certain medication because of the persuasive marketing efforts of a pharmaceutical company. This data may also include other identifying information about the patient, such as prescribed medication, medical condition, geographic location, patient age, and/or other prescribed medications. In 404, this data may be inputted. The data may be inputted, for example, by a clinician, a nurse, a physician's assistant, or any individual capable or authorized to do so. The data may be inputted by an input/output device, such as a keyboard or a mouse. In 406, the information may be forwarded to a practice management system. The EMR process 400 is comprised of 402, 404, 406, and is discussed in application Ser. Nos. 10/141,311 and 10/400,460. In 408, a snapshot of the data may be taken. In 410, the data may be forwarded to an analysis server 116. In 412, analysis rules 118 may be received. For example, the analysis rules may be to choose all patients that are taking a certain prescribed medication, such as Atenolol. As another example, the analysis rules may be to choose all patients from a certain geographic location, such as New Jersey. As another example, the analysis rules may contain multiple parameters, such as to choose all patients between the ages of thirty and forty that suffer from diabetes. In 414, patients may be selected based on the rules. In 416, output data may be forwarded a follow up process. For example, the output data may be the contact information for the identified patients, and the appropriate follow-up instructions. In 418, selected patients may be contacted to encourage them to comply with the recommended dosage of their prescribed medication. For example, all patients over sixty-five with a heart condition may be contacted to be reminded to take their medication. This contact may occur via interactive voice telephony, or any other comparable technology. This contact may be in the form of email, fax, telephone call, letter, or any other mechanism capable of relaying the message to the patient. In 420, selected patients may be provided with educational information informing them of the benefits of complying with the recommended dosage of their medication, step 420. This contact may occur via interactive voice telephony, or any other comparable technology. This contact may be in the form of email, fax, telephone call, letter, or any other mechanism capable of relaying the message to the patient.

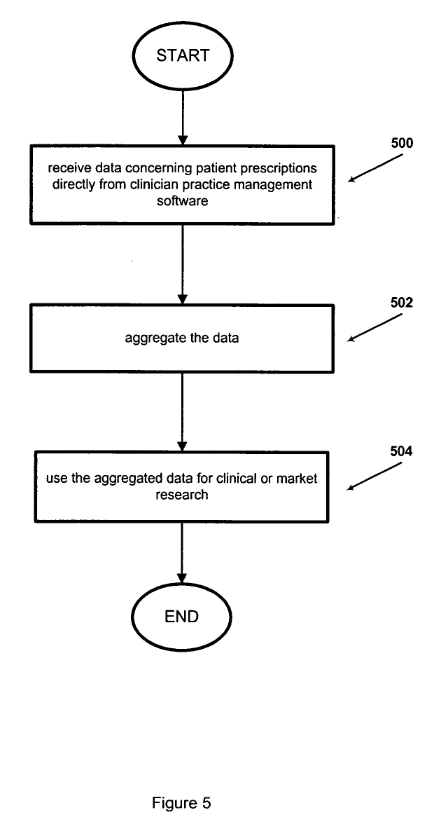

FIG. 5 is a flowchart illustrating another example procedure, according to an example embodiment of the present invention. In 500, patient data concerning prescriptions is received directly from clinician practice management software. In 502, the data may be aggregated. For example, the data may be aggregated by an aggregation system 216. In 504, the aggregated data may be used for clinical or market research.

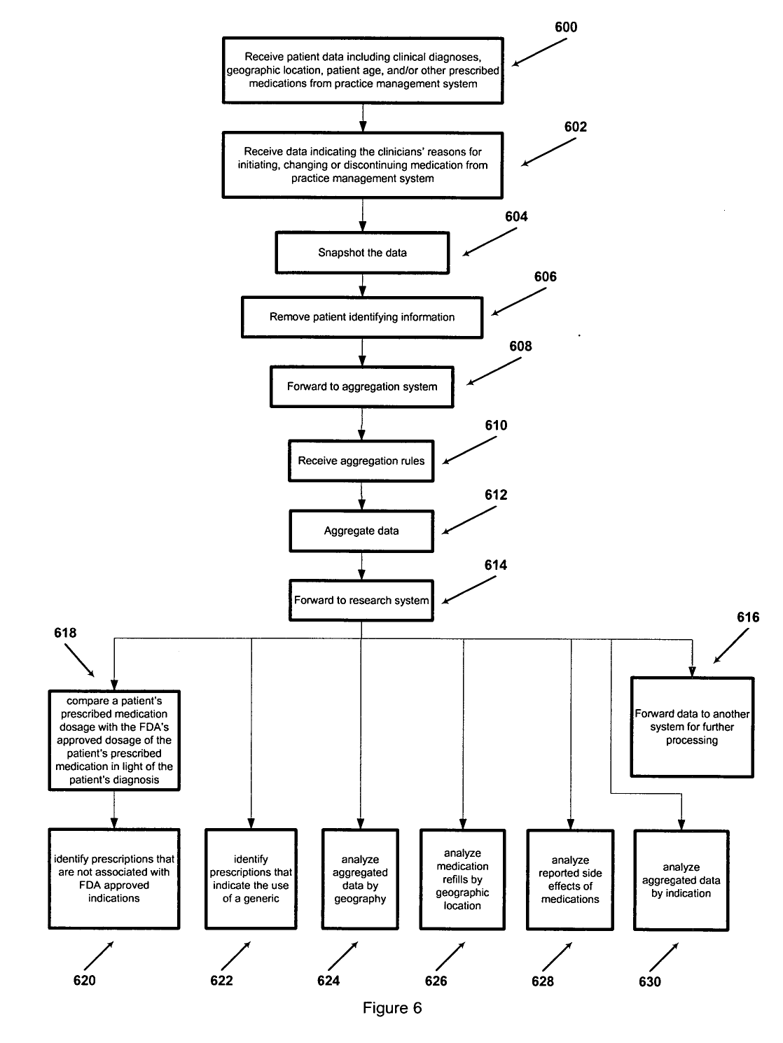

FIG. 6 is a flowchart illustrating another example procedure, according to an example embodiment of the present invention. In 600, patient prescription data may be received. This data may include prescribed medication, medical condition, geographic location, patient age, and/or other prescribed medications. In 602, data indicating the clinicians' reasons for initiating, changing or discontinuing patient medication may also be received. For example, the clinician may discontinue a medication due to adverse side effects. As another example, the clinician may initiate a certain medication due to marketing efforts of the pharmaceutical company. In 604, a snapshot of the data may be taken. In 606, patient identifying information may be removed from the data. This may occur via a privacy filter 215. It may remove such information as patient name, social security number, phone number, address, or any other identifying information. In 608, the data may be forwarded to an aggregation system 216. In 610, aggregation rules 218 may be received. For example, the aggregation rules 218 may be to organize the data according to the patients' prescribed medications. As another example, the aggregation rules may be to organize the data according to the patients' medical conditions. In 612, the data may be aggregated. The aggregation may be done, for example, by the aggregation system 216, which may be a processor, a data processing device or any system capable of organizing the data. In 614, the data may be forwarded to a research system 220. For example, the research system may be a private server, a web-based ASP, or any other system capable of making the aggregated data available to others. In 616, the data may be forwarded to another system for further processing. This other system may be, for example, a processor, a data processing system, or any other system capable of analyzing the data. In 618, a patient's prescribed medication dosage may be compared with the FDA's approved dosage of the medication for someone with the patient's medical condition. In 620, prescriptions that are not associated with FDA approved indications, may be identified. In 622, prescriptions that indicate the use of a generic drug may be identified. In 624, the aggregated data may be analyzed by geography. In 626, medication refills may be analyzed by geographic location. In 628, the reported side effects of medications may be analyzed. In 630, the aggregated data may be analyzed by indication.

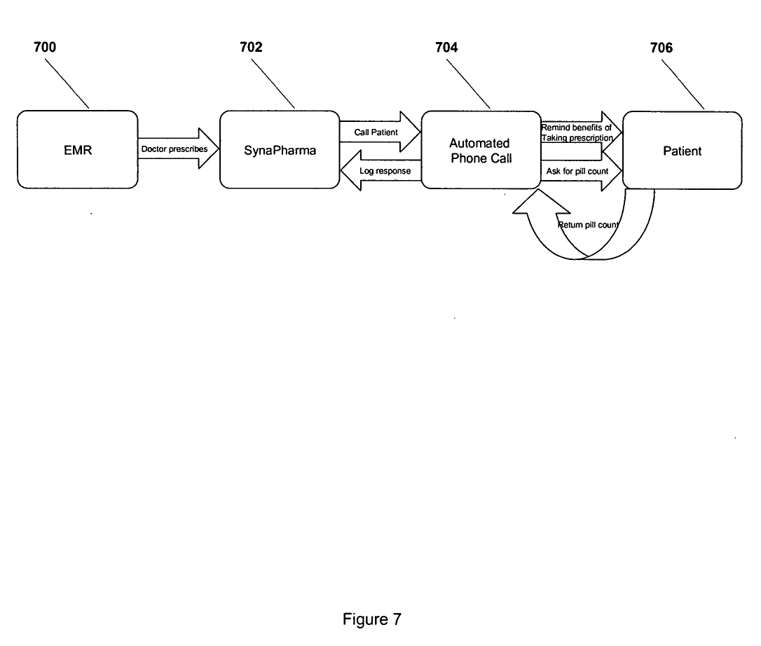

FIG. 7 is a diagram of an embodiment of an application of the present invention. In this embodiment, the EMR system 700 may send the doctor's prescription information to SynaPharma 702. SynaPharma is an example commercial implementation of analysis server 116, IVR server 120, and IVR system 124 of FIG. 1. SynaPharma 702 may then have access to the patient's prescription information, and thus may be able to determine how many pills the patient would have left if the patient was complying with the recommended dosage. SynaPharma 702 may initiate a phone call 704 to the patient 706 to inquire about how may pills the patient has remaining in his current prescription. SynaPharma 702 may make this phone call using interactive voice response (IVR) or another comparable technology. SynaPharma 702 may record the amount of pills the patient has remaining, and store this information. SynaPharma 702 may compare the amount of pills the patient has remaining with the amount of pills that the patient should have remaining if the patient was complying with the recommended dosage. If the amount of pills the patient has remaining is more that the patient should have remaining, SynaPharma 702 may initiate a phone call to remind the patient to take the medication. SynaPharma 702 may make this automatic phone call using interactive voice response (IVR) or another comparable technology.

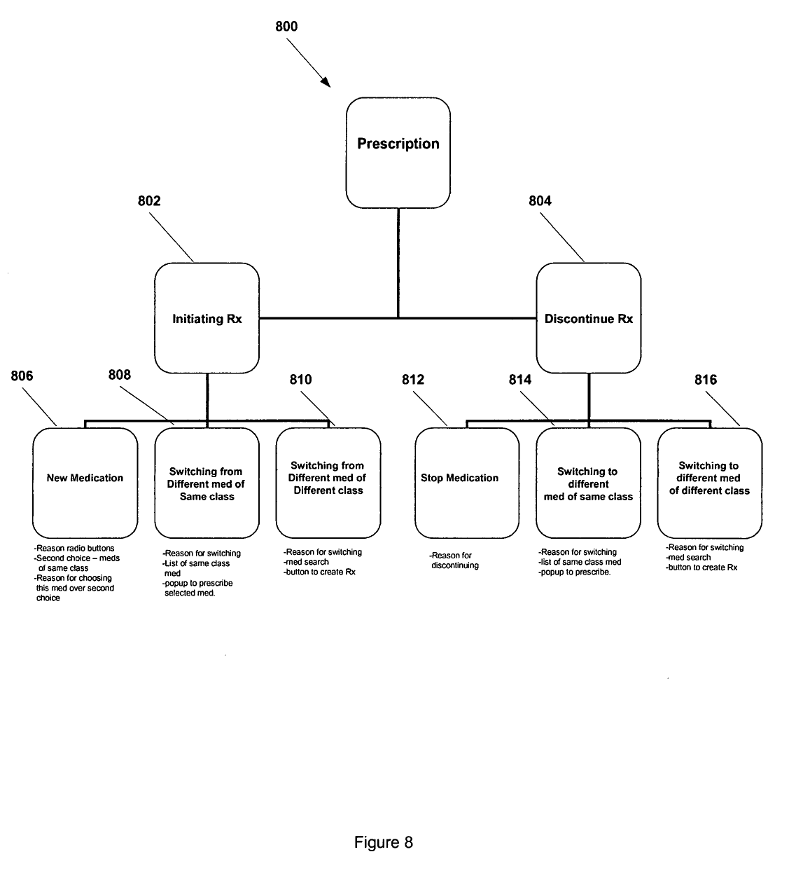

FIG. 8 is a diagram of an embodiment of a decision tree 800 that operates in conjunction with an EMR when the clinician initiates, changes, or discontinues medication. Although FIG. 8 presents an example based on a decision tree data structure, the present invention is compatible with any searchable data structure capable of relating the clinician's choice of prescription modification to other related activities. When the clinician indicates in the EMR that he would like to prescribe a certain medication for a patient, the EMR system may access a decision tree 800. The clinician may traverse the decision tree 800 by entering subsequent details. For example, the clinician may first indicate, that he wishes to initiate a new prescription 802. Then, the clinician may further specify that he is switching from a different medication in the same class of drugs 808. At this point the clinician may be offered several options. He may be asked to indicate the reason for switching medications. He may also be shown a list of medications in the same class, and given the option to choose a different one instead of the one he initially prescribed. Finally, the clinician may be able to prescribe the medication from within the EMR system. The prescription may be sent electronically directly to the pharmacy.

In the preceding specification, the present invention has been described with reference to specific example embodiments thereof. It will, however, be evident that various modifications and changes may be made thereunto without departing from the broader spirit and scope of the present invention as set forth in the claims that follow. The specification and drawings are accordingly to be regarded in an illustrative rather than restrictive sense.

1. A method, comprising:
receiving data from a clinician practice management system, said data including prescription data;
forwarding said data to a server; and
generating a third-party follow-up activity with patients based at least in part on said prescription data.

2. The method of claim 1, wherein the prescription data includes data on prescriptions made by multiple clinicians at multiple locations.

3. The method of claim 1, further comprising:
initially receiving said prescription data at said clinician practice management system by direct input from said clinicians.

4. The method of claim 1, wherein said prescription data includes at least one of initial prescription information, discontinued prescription information, or changed prescription information.

5. The method of claim 1, wherein said follow-up activity includes calling a patient to encourage compliance with the prescription.

6. The method of claim 1, wherein said follow-up activity includes providing the patient with educational information about the benefits of complying with the prescription.

7. The method of claim 1, wherein the follow-up activity occurs by way of interactive voice response telephony.

8. The method of claim 1, wherein said data received also includes at least one of medical condition, geographic location, patient age, or other prescribed medications.

9. The method of claim 8, wherein the patients are identified for the third-party follow-up activity based at least in part on one of prescribed medication, medical condition, geographic location, patient age, or other prescribed medications.

10. The method of claim 1, wherein the patients are identified for the third-party follow-up activity based at least in part on one of prescribed medication, medical condition, geographic location, patient age, or other prescribed medications.

11. The method of claim 1, wherein said data is received from an application service provider providing electronic medical record management for a plurality of clinicians located in multiple locations.

12. A method, comprising:
receiving data directly from clinician practice management software, said data including prescription data;
aggregating said data;
using said aggregated data for at least one of clinical research or market research.

13. The method of claim 12, further comprising:
removing patient identifying information from said data.

14. The method of claim 12, wherein said data is received in real-time.

15. The method of claim 12, wherein said data also includes at least one clinical diagnoses, geographic location, patient age, or other prescribed medications.

16. The method of claim 12, wherein said data includes at least one of a clinician's reasons for initiating medication, a clinician's reasons for changing medication, or a clinician's reasons for discontinuing medication.

17. The method of claim 12, further comprising:
comparing a patient's prescribed medication dosage with the FDA's approved dosage of the patient's prescribed medication in light of the patient's diagnosis.

18. The method of claim 17, further comprising:
identifying prescriptions that are not associated with FDA approved indications.

19. The method of claim 12, further comprising:
identifying prescription that indicate the use of a generic.

20. The method of claim 12, further comprising:
analyzing the aggregated data by geography.

21. The method of claim 12, further comprising:
analyzing medication refills by geographic location.

22. The method of claim 12, further comprising:
analyzing reported side effects of medications.

23. The method of claim 12 further comprising:
analyzing the aggregated data by indication.

24. The method of claim 12, wherein said data is received from an application service provider providing electronic medical record management for a plurality of clinicians located in a plurality locations.

25. A medical information system, comprising:
an input device to receive prescription data and patient medical data in a clinical setting;
a server to receive said prescription and patient data from a plurality of clinicians in a plurality of locations;
a processor to aggregate said data;
an output device to output said aggregated data.

26. The system of claim 25, wherein the output device is operable to display a report using the aggregated data.

27. The system of claim 25, wherein the output device is operable to send the aggregated data to another processor for analysis.

28. The system of claim 25, wherein the processor is further operable to remove patient identifying information from the prescription data and patient medical data.

29. The system of claim 25, wherein the processor is operable to aggregate said prescription and patient data in real-time.

30. The system of claim 25, wherein said patient medical data includes at least one of clinical diagnoses, geographic location, patient age, or other prescribed medications.

31. The system of claim 25, wherein said prescription data includes the clinicians' reasons for initiating, changing, or discontinuing medication.

32. The system of claim 25, wherein the server is an application service provider providing practice data management for the plurality of clinicians in the plurality of locations.

33. A medical information system, comprising:
an input device to receive prescription data and patient medical data in a clinical setting;
a server in communication with the input device to receive said prescription and patient data from a plurality of clinicians in a plurality of locations;
a processor in communication with the server to select a plurality of patients for a third-party follow-up activity based on said data;
an output device in communication with the processor to facilitate a third-party follow-up activity for said plurality of patients selected by the processor.

34. The system of claim 33, wherein said prescription data includes at least one of initial prescription information, discontinued prescription information, or changed prescription information.

35. The system of claim 33, wherein the output device is configured to operate by interactive voice recognition telephony.

36. The system of claim 33, wherein the output device is operable to call a patient to encourage compliance with a prescription.

37. The system of claim 33, wherein the output device is operable to provide the patient with educational information about the benefits of complying with a prescription.

38. The system of claim 33, wherein said patient medical data received includes at least one of medical condition, geographic location, patient age, or other prescribed medications.

39. The system of claim 38, wherein the processor is configured to identify patients for the third-party follow-up activity based at least in part on one of prescribed medication, medical condition, geographic location, patient age, or other prescribed medications.

40. The system of claim 33, wherein the server is an application service provider providing an electronic medical record system for the plurality of locations.
